(19) United States
(12) Patent Application Publication
(10) Pub. No.: US 2002/0138417 A1
(43) Pub. Date: Sep. 26, 2002

(54) Risk management clearinghouse

(76) Inventor: David Lawrence, New York, NY (US)

Correspondence Address: Buckley, Maschoff, Talwalkar & Allison LLC, 5 Elm Street, New Camaam, CT, 06840, US

(21) Appl. No.: 10/074,584

(22) Filed: Feb. 12, 2002

Related U.S. Application Data
(63) Continuation-in-part of application No. 10/021,124, filed on Oct. 30, 2001.
Application No. 10/021,124 is a continuation-in-part of application No. 09/812,627, filed on Mar. 20, 2001.

(51) Int. Cl. G06F 17/60

(52) U.S. Cl. 705/38

(57) ABSTRACT

A method and system for managing risk associated with government regulation is provided. Data relevant to regulation can be gathered from multiple sources and aggregated according to risk variables. An inquiry relating to a risk subject can be received and portions of the aggregated data can be associated with the risk subject. A risk subject can include, for example, a financial transaction, or a party involved in a financial transaction. The associated portions of the aggregated data can then be transmitted, such as for example, to a subscriber that submitted the risk subject. In one embodiment, the gathered data can be gathered exclusively from publicly available sources. In addition, the inquiry received can be a system to system inquiry involving an individual request or batch screening requests received electronically. Requests can also include a voice communication or a facsimile.

### CROSS REFERENCE TO RELATED APPLICATIONS

This application is a continuation-in-part of a prior application entitled “Risk Management Clearinghouse” filed Oct. 30, 2001, and bearing the Ser. No. 10/021,124, which is also a continuation-in-part of a prior application entitled “Automated Global Risk Management” filed Mar. 20, 2001, and bearing the Ser. No. 09/812,627, both of which are relied upon and incorporated by reference.

### BACKGROUND

This invention relates generally to a method and system for facilitating the identification, investigation, assessment and management of legal, regulatory financial and reputational risks (“Risks”). In particular, the present invention relates to a computerized system and method for banks and non-bank financial institutions to access information compiled on a worldwide basis and relate such information to a risk subject, such as a transaction at hand, wherein the information is conducive to quantifying and managing financial, legal, regulatory and reputational risk associated with the transaction.

As money-laundering and related concerns have become increasingly important public policy concerns, regulators have attempted to address these issues by imposing increasing formal and informal obligations upon financial institutions. Government regulations authorize a broad regime of record-keeping and regulatory reporting obligations on covered financial institutions as a tool for the federal government to use to fight drug trafficking, money laundering, and other crimes. The regulations may require financial institutions to file currency and monetary instrument reports and to maintain certain records for possible use in tax, criminal and regulatory proceedings. Such a body of regulation is designed chiefly to assist law enforcement authorities in detecting when criminals are using banks and other financial institutions as intermediaries for, or to hide the transfer of funds derived from, criminal activity.

Obligations include those imposed by the Department of the Treasury and the federal banking regulators which adopted suspicious activity report (“SAR”) regulations. These SAR regulations require that financial institutions file SARs whenever an institution detects a known or suspected violation of federal law, or a suspicious transaction related to a money laundering activity or a violation of the BSA. The regulations can impose a variety of reporting obligations on financial institutions. Perhaps most broadly relevant for the present invention, they require an institution to report transactions aggregating to $5,000 that involve potential money laundering or violations if the institution, knows, suspects, or has reason to suspect that the transaction involves funds from illegal activities, is designed to disguise such funds, has no business or legitimate purpose, or is simply not the sort of transaction in which the particular customer would normally be expected to engage, and the institution knows of no reasonable explanation for the transaction after examining the available facts.

For example, banks must retain a copy of all SARs and all supporting documentation or equivalent business records for 5 years from the date of the filing of the SAR. Federal banking regulators are responsible for determining financial institutions' compliance with the BSA and implementing regulations.

Federal regulators have made clear that the practical effect of these requirements is that financial institutions are subject to significant obligations to “know” their customer and to engage in adequate monitoring of transactions.

Bank and non-bank financial institutions, including: investment banks; merchant banks; commercial banks; securities firms, including broker dealers securities and commodities trading firms; asset management companies, hedge funds, mutual funds, credit rating funds, securities exchanges and bourses, institutional and individual investors, law firms, accounting firms, auditing firms, any institution the business of which is engaging in financial activities as described in section 4(k) of the Bank Holding Act of 1956, and other entities subject to legal and regulatory compliance obligations with respect to money laundering, fraud, corruption, terrorism, organized crime, regulatory and suspicious activity reporting, sanctions, embargoes and other regulatory risks and associated obligations, hereinafter collectively referred to as “Financial Institutions,” typically have few resources available to them to assist in the identification of present or potential risks associated with business transactions. Risk can be multifaceted and far reaching. Generally, personnel do not have available a mechanism to provide real time assistance to assess a risk factor or otherwise qualitatively manage risk. In the event of problems, it is often difficult to quantify to regulatory bodies, shareholders, newspapers and other interested parties, the diligence exercised by the Financial Institution to properly identify and respond to risk factors. Absent a means to quantify good business practices and diligent efforts to contain risk, a financial institution may appear to be negligent in some respect.

Risk associated with maintaining an investment account, or other financial account, can include factors associated with financial risk, legal risk, regulatory risk and reputational risk. Financial risk includes factors indicative of monetary costs that the financial institution may be exposed to as a result of performing a particular transaction. Monetary costs can be related to fines, forfeitures, costs to defend an adverse position, lost revenue, or other related potential sources of expense. Regulatory risk includes factors that may cause the financial institution to be in violation of rules put forth by a regulatory agency such as the Securities and Exchange Commission (SEC). Reputational risk relates to harm that a financial institution may suffer regarding its professional standing in the industry. A financial institution can suffer from being associated with a situation that may be interpreted as contrary to an image of honesty and forthrightness. Such risks can also befall other entities, such as for example, without limitation, in situations known as “white goods” money laundering.

Risk associated with an account involved in international transactions can be greatly increased due to the difficulty in gathering and accessing pertinent data on a basis timely to managing risk associated with the transaction. As part of due diligence associated with performing financial, it is imperative for a financial institution to “Know Their Customer” including whether a customer is contained on a list of restricted entities published by the Office of Foreign Access Control (OFAC), the Treasury Office or other government or industry organization.

Compliance officers and other financial institution personnel typically have few resources available to assist them with the identification of present or potential global risks associated with a particular investment or trading transaction. Risks can be multifaceted and far reaching. The amount of information that needs to be considered to evaluate whether an international entity poses a significant risk or should otherwise be restricted, is substantial.

However, financial institutions do not have available a mechanism which can provide real time assistance to assess a risk factor associated with an international transaction, or otherwise qualitatively manage such risk. In the event of investment problems, it is often difficult to quantify to regulatory bodies, shareholders, newspapers and/or other interested parties, the diligence exercised by the financial institution to properly identify and respond to risk factors. Absent a means to quantify good business practices and diligent efforts to contain risk, a financial institution may appear to be negligent in some respect.

General data services that are available to search news sources and other public information will accept a query and return a result. However, such services are not integrated into a risk management system. In addition, present data services only return a flat response to a query submitted without any further data mining or scrubbing. The inefficiency of having to manually ascertain what terms should be searched and then submit query that includes those terms makes these systems overbearing on a transaction by transaction basis. Also, over time, databases can accrue a wide range of inaccuracies and inconsistencies, such as misspelled names, inverted text, missing fields, alternate spelling of key phrases, and other blemishes. Fixing such faulty records by hand on a timeframe needed to perform risk management associated with a financial transaction may be impossible as well as expensive and could result in the introduction of even more errors.

What is needed is a method and system to draw upon information gathered globally and utilize the information to assist with risk management and due diligence related to financial transactions. A new method and system should anticipate scrubbing data from multiple sources in order to facilitate merging data from all necessary sources. In addition, data mining should be made available to ascertain patterns or anomalies in the query results. Risk information should also be situated to be conveyed to a compliance department and be able to demonstrate to regulators that a financial institution has met standards relating to risk containment.

### SUMMARY

Accordingly, the present invention provides a method for managing risk associated with government regulation, which includes gathering data relevant to regulation from multiple sources and aggregating the data gathered according to risk variables. An inquiry relating to a risk subject can be received and portions of the aggregated data can be associated with the risk subject. A risk subject can include, for example, a financial transaction, or a party involved in a financial transaction. The associated portions of the aggregated data can then be transmitted, such as for example, to a subscriber that submitted the risk subject.

In one embodiment, the gathered data can be gathered exclusively from publicly available sources. In addition, the inquiry received can be a system to system inquiry involving an individual request or batch screening requests received electronically. Requests can also include a voice communication or a facsimile.

In one aspect a contractual obligation can be required not to use the associated portions of the aggregated data for any purpose covered by the Fair Credit Reporting Act. If desired, transmission of the associated portions of the aggregated data can be conditioned upon receipt of the contractual obligation not to use the associated portions of the aggregated data for any purpose covered by the Fair Credit Reporting Act.

In another aspect, associated portions of the aggregated data can be transmitted exclusively to an institution, such that the transmitter will have neither customers nor consumers as defined in the Gramm-Leach-Bliley Act. In addition, transmission of the associated portions of the aggregated data can be conditioned upon receipt of a contractual obligation to limit use of the aggregated data for complying with regulatory and legal obligations associated with at least one of: (i) the detection and prevention of money laundering, (ii) fraud, (iii) corrupt practices, (iv) organized crime, and (v) activities subject to government sanctions or embargoes. Other conditions of transmission can include receipt of a contractual obligation to limit use of the aggregated data for at least one of: (i) the prevention or detection of a crime, (ii) the apprehension or prosecution of offenders, and (iii) the assessment or collection of a tax or duty.

Another particular embodiment can limit risk subjects to commercial entities. Similarly gathered data relevant to regulation can be limited to data that does not include information sourced from a credit report. Gathered data can also be limited to data relevant to regulation that accurately reports on or consists of a governmental record or is from a source that is reputable.

In addition, provider of a computer-implemented method for managing risk associated with government regulation can be precluded from creating or developing any of the associated portions of the aggregated data transmitted. Similarly, the aggregated data can be precluded from including any consumer reporting data.

A risk subject can also include an alert list wherein the aggregated data can continually monitor the aggregated data and transmit any new information related the risk subject.

In still another embodiment, the present invention can include enhancing the gathered data or the risk subject, such as for example, by scrubbing the data or utilizing an index file. Scrubbing the data can include, incorporating changes in the spelling of the risk subject.

Similarly, associated portions of aggregated data can be augmenting using such techniques as data mining. A source of gathered data can also be recorded and transmitted to a subscriber.

Other embodiments of the present invention can include a computerized system, executable software, or a data signal implementing the inventive methods of the present invention. The computer server can be accessed via a network access device, such as a computer. Similarly, the data signal can be operative with a computing device, and computer code can be embodied on a computer readable medium.

In another aspect, the present invention can include a method and system for a user to interact with a network access device so as to manage risk relating to a risk subject. The user can initiate interaction with a proprietary risk management server via a communications network and input information relating to details of the risk subject, such as, for example, via a graphical user interface, and receive back a information related to the risk subject.

Various features and embodiments are further described in the following figures, drawings and claims.

### DESCRIPTION OF THE DRAWINGS

FIG. 1 illustrates a block diagram that can embody this invention.

FIG. 2 illustrates a network of computer systems that can embody an automated RMC risk management system.

FIG. 3 illustrates a flow of exemplary steps that can be executed by a system implementing the present invention.

FIG. 4 illustrates a flow of exemplary steps that can be executed by a system to implement augmented data.

FIG. 5 illustrates a flow of exemplary steps that can taken by a user of the RMC risk management system.

### DETAILED DESCRIPTION

The present invention includes a computerized method and system for managing risk associated with a financial transaction. A computerized system gathers and stores information as data in a database or other data storing structure and processes the data in preparation for a risk inquiry search relating to a risk subject, such as a party involved in a financial transaction. Documents and sources of information can also be stored. A subscriber, such as a Financial Institution, can submit a risk management subject for which a risk inquiry search can be performed. The risk assessment or inquiry search can include data retrieved resultant to augmented retrieval methods. Scrubbed data as well as augmented data can be transmitted from a risk management clearinghouse (RMC) to a subscriber or to a proprietary risk system utilized by a subscriber, such as a risk management system maintained in-house. Risk inquiry searches can be automated and made a part of standard operating procedure for each transaction conducted by the subscriber.

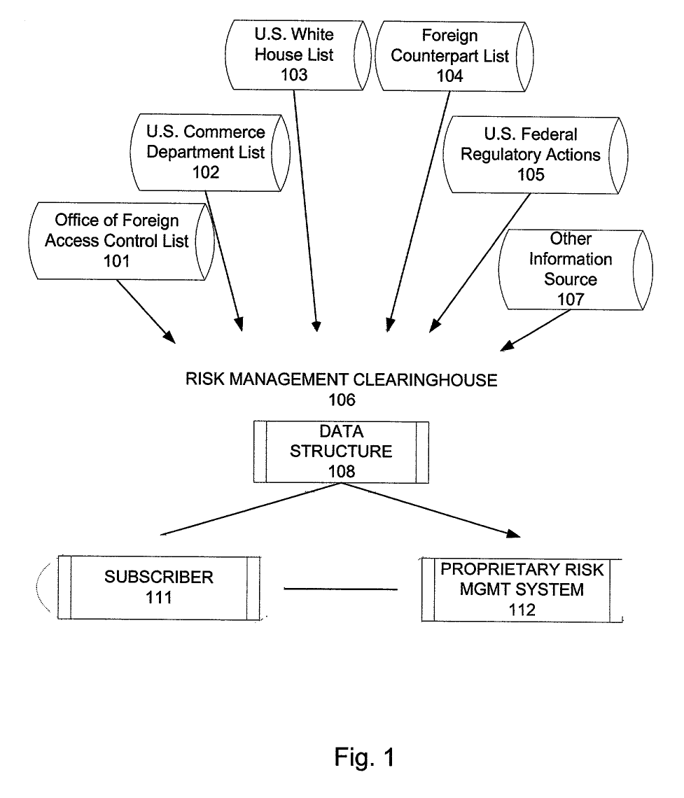

Referring now to FIG. 1 a block diagram of one embodiment of the present invention is illustrated. An RMC system 106 gathers and receives information which may be related to risk variables in a financial transaction. Information may be received, for example, from publicly available sources 101-105, subscribers 111, investigation entities, or other sources. The information is constantly updated and can be related to a financial transaction or an alert list in order to facilitate compliance with regulatory requirements. The RMC system 106 facilitates due diligence on the part of a subscriber 111 by gathering, structuring and providing to the subscriber 111 data that relates to risk variables involved in a financial transaction.

A risk variable can be any data that can cause a risk level to change. A financial institution has an obligation to relate such variables to suspicious activity and also to know their customers. For example, Financial Institution may need information on an individual who is a party to a transaction, or a corporation or other institutional entity that is involved in the transaction. Other risk variables can include for exemplary purposes, a sovereign state involved, a geographic area, a shell bank, a correspondent account, a political figure, a person close to a political figure, a history of fraud, embargoes, sanctions, or other factors.

Risk variable related information can also be received from formalized lists, such as, for example: a list generated by the Office of Foreign Assets Control (OFAC) 101 including their sanction and embargo list, a list generated by the U.S. Commerce Department 102, a list of international “kingpins” generated by the U.S. White House 103, foreign Counterpart list 104, U.S. regulatory actions 105 or other information source 107 such as a foreign government, U.S. adverse business-related media reports, U.S. state regulatory enforcement actions, international regulatory enforcement actions, international adverse business-related media reports, a list of politically connected individuals and military leaders, list of U.S. and international organized crime members and affiliates, a list put forth by the Financial Action Task Force (FATF), a list of recognized high risk countries, or other source of high risk variables. Court records or other references relating to fraud, bankruptcy, professional reprimand or a rescission of a right to practice, suspension from professional ranks, disbarment, prison records or other source of suspect behavior can also be an important source of information. Of additional interest can be information indicative that an entity is not high risk such as a list of corporations domiciled in a G-7 country, or a list of entities traded on a major exchange.

A subscriber 111 can include, for example: a securities broker, a retail bank, a commercial bank, investment and merchant bank, private equity firm, asset management company, a mutual fund company, a hedge fund firm, insurance company, a credit card issuer, retail or commercial financier, a securities exchange, a regulator, a money transfer agency, bourse, an institutional or individual investor, an auditing firm, a law firm, any institution the business of which is engaging in financial activities as described in section 4(k) of the Bank Holding Act of 1956 or other entity or institution who may be involved with a financial transaction or other business transaction or any entity subject to legal and regulatory compliance obligations with respect to money laundering, fraud, corruption, terrorism, organized crime, regulatory and suspicious activity reporting, sanctions, embargoes and other regulatory risks and associated obligations. Information supplied by a subscriber may be information gathered according to normal course of dealings with a particular entity. In addition, in accordance with prevailing law, a financial institution may discover or suspect that a person or entity is involved in some fraudulent or otherwise illegal activity and report this information to the RMC system 106.

Similarly, financial investments can include investment and merchant banking, public and private financing, commodities and a securities trading, commercial and consumer lending, asset management, rating of corporations and securities, public and private equity investment, public and private fixed income investment, listing to companies on a securities exchange and bourse, employee screening, auditing of corporate or other entities, legal opinions relating to a corporate or other entity, or other business related transactions.

A subscriber 111, such as a financial institution, will often be closely regulated. As a result financial institutions are exposed to significant risks from their obligations of compliance with the law and to prevent, detect and, at times, report potential violations of laws, regulations and industry rules (“laws”). These risks include, but are not limited to, the duty to disclose material information, and to prevent and possibly report: fraud, money laundering, foreign corrupt practices, bribery, embargoes and sanctions. Timely access to relevant data on which to base a compliance related action can be critical to conducting business and comply with regulatory requirements such as those set forth by the Patriot Act in the United States.

A decision by a financial institution concerning whether to pursue a financial transaction can be dependent upon many factors. A multitude and diversity of risks related to the factors may need to be identified and evaluated. In addition, the weight and commercial implications of the factors and associated risks can be interrelated. The present invention can provide a consistent and uniform method for business, legal, compliance, credit and other personnel of financial institutions to identify and assess risks associated with a transaction. An RMC system 106 allows investment activity risks to be identified, correlated and quantified by a financial institution on a confidential basis thereby assessing legal, regulatory, financial and reputational exposure.

A financial institution can integrate an RMC system 106 to be part of legal and regulatory oversight for various due diligence and “know your customer” obligations imposed by regulatory authorities. The RMC system 106 can facilitate detection and reporting of potential violations of law, and in one embodiment, address the “suitability” of a financial transaction and/or the assessment of sophistication of a customer. Similarly, the RMC system 106 can support a financial institution's effort to meet requirements regarding the maintenance of accurate books and records relating to their financial transactions and affirmative duty to disclose material issues affecting an investor's decisions.

Information gathered from the diversity of data sources can be aggregated into a searchable data storage structure 108. A source of information can also be received and stored. In some instances a subscriber 111 may wish to receive information regarding the source of information received. Gathering data into an aggregate data structure 108, such as a data warehouse allows a RMC system 106 to have the data 108 readily available for processing a risk management search associated with a risk subject. Aggregated data 108 can also be scrubbed or otherwise enhanced.

In one embodiment of enhancing data, data scrubbing can be utilized to implement a data warehouse comprising the aggregate data structure 108. The data scrubbing takes information from multiple databases and stores it in a manner that gives faster, easier and more flexible access to key facts. Scrubbing can facilitate expedient access to accurate data commensurate with the critical business decisions that will be based upon the risk management assessment provided.

Various data scrubbing routines can be utilized to facilitate aggregation of risk variable related information. The routines can include programs capable of correcting a specific type of mistake, such as an incomprehensible address, or clean up a full spectrum of commonly found database flaws, such as field alignment that can pick up misplaced data and move it to a correct field or removing inconsistencies and inaccuracies from like data. Other scrubbing routines can be directed directly towards specific legal issues, such as money laundering or terrorist tracking activities.

For example, a scrubbing routine can be used to facilitate various different spelling of one name. In particular, spelling of names can be important when names have been translated from a foreign language into English. For example, some languages and alphabets, such as Arabic, have no vowels. Translations from Arabic to English can be very important for financial institutions seeking to be in compliance with lists supplied by the U.S. government that relate to terrorist activity and/or money laundering. A data scrubbing routine can facilitate risk variable searching for multiple spellings of an equivalent name or other important information. Such a routine can enhance the value of the aggregate data gathered and also help correct database flaws. Scrubbing routines can improve and expand data quality more efficiently than manual mending and also allow a subscriber 111 to quantify best practices for regulatory purposes.

Retrieving information related to risk variables from the aggregated data is an operation with the goal to fulfill a given a request. In order to process request against a large document set of aggregated risk data with a response time acceptable to the user, it may be necessary to utilize an index based approach to facilitate acceptable response times. A direct string comparison based search may be unsuitable for the task.

An index file for a collection of documents can therefore be built upon receipt of the new data and prior to a query or other request. The index file can include a pointer to the document and also include important information contained in the documents the index points to. At query time, the RMC system 106 can match the query against a representation of the documents, instead of the documents themselves. The RMC system 106 can retrieve the documents referenced by the indexes that satisfy the request if the subscriber submits such a request. However it may not be necessary to retrieve the full document as index records may also contain the relevant information gleaned from the documents they point to. This allows the user to extract information of interest without having to read the source document.

At least two retrieval models can be utilized in fulfilling a search request: a) Boolean, in which the document set is partitioned in two disjoint parts: one fulfilling the query and one not fulfilling it, and b) relevance ranking based in which all the documents are considered relevant to a certain degree. Boolean logic models use exact matching, while relevance ranking models use fuzzy logic, vector space techniques (all documents and the query are considered vectors in a multidimensional space, where the shorter the distance between a document vector and the query vector, the more relevant is the document), neural networks, and probabilistic schema. In a relevance ranking model, low ranked elements may even not contain the query terms.

Augmenting data can include data mining techniques that use of sophisticated software to analyze and sift through the aggregated data stored in the warehouse using techniques such as mathematical modeling, statistical analysis, pattern recognition, rule based trends or other data analysis tools. In contrast to traditional systems that may have gathered and stored information in a flat file and regurgitated the stored information when requested, such as in a defined report related to a specific risk subject or other ad hoc access concerned with a particular query at hand, the present invention can provide risk related searching that adds a discovery dimension by returning results that human operator would find very labor and cognitively intense.

This discovery dimension supplied by the RMC system 106 can be accomplished through the application of augmenting techniques, such as data mining applied to the risk related data that has been aggregated. Data mining can include the extraction of implicit, previously unknown and potentially useful information from the aggregated data. This type of extraction can include unlooked for correlations, patterns or trends. Other techniques that can be applied can include fuzzy logic and/or inductive reasoning tools.

For example, augmenting routines can include enhancing available data with routines designed to reveal hidden data. Revealing hidden data or adding data fields derived from existing data can be very useful to risk management. For example, is supplied data may not include an address for a person wishing to perform a financial transaction; however a known telephone number is available. Augmented data can include associating the telephone number with a known geographic area. The geographic area may be a political boundary, or coordinates, such as longitude and latitude coordinates, or global positioning coordinates. The geographic area identified can then be related to high risk or low risk areas.

An additional example of augmented data derived from a telephone number would include associating the given telephone number with a high risk entity, such as a person listed on an OFAC list. Other inconsistencies can also be brought to light, for example, if a person in Europe wishes to perform a high value transaction denominated in a currency of a mid-eastern Arab nation through an African bank, augmented data may include a statistical analysis of how often such a transaction takes place on a global basis. The analysis would not place a value judgment on the proposed transaction, but would present the statistics for a compliance person to evaluate.

In one embodiment, a subscriber 111 would access the RMC system 106 via a computerized system as discussed more fully below. The subscriber would input a description of a risk subject, or other inquiry, such as the name of a party attempting to perform a financial transaction. In some instances, and in accordance with applicable laws, other identifying information can also be input, such as a date of birth, a place of birth, a social security number or other identifying number, or any other descriptive information. The RMC system 106 would receive the identifying information and perform a risk related inquiry or search on the scrubbed data.

In another embodiment, a subscriber 111 can house a computerized proprietary risk management (PRM) system 112. The PRM system 112 can receive an electronic feed from an RMC system 106 with updated scrubbed data. In addition, data mining results can also be transmitted to the PRM system 112 or performed by the PRM system 112 for integration into the risk management practices provided by in-house by the subscriber.

Information entered by a subscriber into a PRM system 112 may be information gathered according to normal course of dealings with a particular entity or as a result of a concerted investigation. In addition, since the PRM system 112 is proprietary and a subscriber responsible for the information contained therein can control access to the information contained therein, the PRM system 112 can include information that is public or proprietary. If desired, information entered into the PRM system 112 can be shared with a RMC system 106. Informational data can be shared, for example via an electronic transmission or transfer of electronic media. However, RMC system 106 data may be subject to applicable local or national law and safeguards should be adhered to in order to avoid violation of such law through data sharing practices. In the event that a subscriber, or other interested party, discovers or suspects that a person or entity is involved in a fraudulent or otherwise illegal activity, the system can report related information to an appropriate authority.

The RMC system 106 provides updated input into an in-house risk management database contained in a PRM system 112. The utilization of a RMC system 106 in conjunction with a PRM system 112 can allow a financial institution, or other subscriber, to screen the names of any or all current and/or prospective account holders and/or wire transfer receipt/payment parties through various due diligence checks on a very low cost and timely basis.

A log or other stored history can be created by the RMC system 106 and/or a PRM system 112, such that utilization of the system can mitigate adverse effects relating to a problematic account. Mitigation can be accomplished by demonstrating to regulatory bodies, shareholders, news media and other interested parties that corporate governance is being addressed through tangible risk management processes.

In the case of an automated transaction, such as, for example, execution of an online transaction, a direct feed of information can be implemented from a front end system involved in the transaction to the RMC system 106 or a PRM system 112. Questions can also be presented to a transaction initiator by a programmable robot via a GUI. Questions can relate to a particular type of account, a particular type of client, types of investment, or other criteria. Other prompts or questions can aid a financial institution ascertain the identity of an account holder and an account's beneficial owner. If there is information indicating that a proposed transaction is related to an account that is beneficially owned by a high risk entity, the financial institution may not wish to perform the transaction if it is unable to determine the identity of the high risk entity and his or her relationship to the account holder.

The RMC system 106 can also receive open inquiries, such as, for example, from subscriber personnel not necessarily associated with a particular transaction. An open query may, for example, search for information relating to an individual or circumstance not associated with a financial transaction and/or provide questions, historical data, world event information and other targeted information to facilitate a determination of risk associated with a risk subject, such as a query regarding an at risk entity's source of wealth or of particular funds involved with an account or transaction in consideration. Measures can also be put in place to insure that all such inquiries should be subject to prevailing law and contractual obligations.

A query can also be automatically generated from monitoring transactions being conducted by a subscriber 111. For example, an information system can electronically scan transaction data for key words, entity names, geographic locales, or other pertinent data. Programmable software can be utilized to formulate a query according to suspect names or other pertinent data and run the query against a database maintained by the RMC system 106. Other methods can include voice queries via a telephone or other voice line, such as voice over internet, fax, electronic messaging, or other means of communication. A query can also include direct input into a RMC system 106, such as through a graphical user interface (GUI) with input areas or prompts.

Prompts or other questions proffered by the RMC system 106 can also depend from previous information received. Information generally received, or received in response to the questions, can be input into the RMC system 106 from which it can be utilized for real time risk assessment and generation of a risk quotient 108.

An alert list containing names and/or terms of interest to a subscriber 111 can be supplied to the RMC system 106 by a subscriber 111 or other source. Each list can be customized and specific to a subscriber 111. The RMC system 106 can continually monitor data in its database via an alert query with key word, fuzzy logic or other search algorithms and transmit related informational data to the interested party. In this manner, ongoing diligence can be conducted. In the event that new information is uncovered by the alert query, the subscriber 111 can be immediately notified, or notified according to a predetermined schedule. Appropriate action can be taken according to the information uncovered.

The RMC system 106 can quantify risk due diligence by capturing and storing a record of information received and actions taken relating to a Financial Transaction. Once quantified, the due diligence data can be utilized for presentation, as appropriate, to regulatory bodies, shareholders, news media and/or other interested parties, such presentation may be useful to mitigate adverse effects relating to a problematic transaction. The data can demonstrate that corporate governance is being addressed through tangible risk management processes.

In one embodiment, the RMC database can contain only information collected from publicly-available sources relevant for the detection and prevention of money laundering, fraud, corrupt practices, organized crime, activities subject to governmental sanctions or embargoes, or other similar activities that are the subject of national and/or global regulation. A subscriber 111 will use the database to identify the possibility that a given individual is involved in such illegal activities and to monitor their customers' use of the subscriber's financial services or product to identify transactions that may be undertaken in furtherance of such illegal activities.

A subscriber 111 to the RMC system 106 will be able to access the database electronically and to receive relevant information electronically and, in specific circumstances, hard copy format. If requested, an RMC system 106 provider can alert a subscriber 111 upon its receipt of new RMC system 106 entries concerning a previously screened individual. A subscriber 111 will be permitted to access information in the RMC system 106 in various ways, including, for example: system to system inquires involving single or batch screening requests, individual inquiries (submitted electronically, by facsimile, or by phone) for smaller screening requests, or through a web-based interface supporting an individual look-up service. Generally, employees and vendors will not be permitted to use or share to information about subscriber requests unless such access is necessary to provide a requested product or service or to fulfill legal obligations under prevailing law.

In one embodiment, an RMC system 106 can take any necessary steps so as not to be regulated as a consumer reporting agency. Such steps may include not collecting or permitting others to use (and therefore does not expect others to use) information from the RMC database to establish an individual's eligibility for consumer credit or insurance, other business transactions, or for employment or other Fair Credit Reporting Act (FCRA) covered purposes such as eligibility for a government benefit or license.

To satisfy the requirements of this embodiment, a subscription agreement can be established between the RMC system 106 provider and a subscriber which will create enforceable contractual provisions prohibiting the use of data from the RMC database for such purposes. The operations of the RMC system 106 can be structured to minimize the risk that the RMC database will be used to furnish consumer reports and therefore become subject to the FCRA. Additional policies and practices can also be established to achieve this objective, such as, for example: the information in the RMC database can be collected only from reputable, publicly available sources and not contain information from consumer reports; the RMC system 106 can collect and permit others to use the information only for the purpose of complying with regulatory and legal obligations associated with the detection and prevention of money laundering, fraud, corrupt practices, organized crime, activities subject to governmental sanctions or embargoes, or other illegal activities that are the subject of national and/or global regulation; the RMC system 106 can forego collection of or permit others to use, information from the database to establish an individual's eligibility for consumer credit or insurance, other business transactions, or for employment or other FCRA-covered purposes.; subscribers can be required to execute a licensing agreement that will limit their use of the data to specified purposes, including specifically that the subscriber will not use the information to determine a consumer's eligibility for any credit, insurance, other business transaction or for employment or other FCRA-covered purposes each subscriber can be required to certify that the subscriber will use the data only for such specified purposes, and to certify annually that the subscriber remains in compliance with these principles.

A licensing agreement can also require that subscribers separately secure information from non-RMC system 106 sources to satisfy any need the subscriber has for information to be used in connection with the subscriber's determination regarding a consumer's eligibility for credit, insurance, other business transactions, or employment or for other FCRA-covered purposes.

In another aspect, if desired, in one embodiment of an RMC system 106, a provider can provide services exclusively to other financial institutions or business entities, such that the RMC system 106 provider will have neither “customers” nor “consumers” as those terms are defined in the Gramm-Leach-Bliley Act (GLBA) and therefore may have no notice or disclosure obligations under the GLBA. In addition, a subscriber's disclosure of the name of its customer to an RMC system 106 may be permitted for institutional risk control and other purposes under the GLBA. An RMC system 106 provider can be contractually obligated to use customer names received from a subscriber only for the purpose of fulfilling that subscriber's request for information or for another purpose permitted by the GLBA, ensuring that the Act's limits on re-use and re-disclosure are met.

In another embodiment, an RMC system 106 may allow dissemination of database information for purposes including: the prevention or detection of crime; the apprehension or prosecution of offenders; or the assessment or collection of any tax or duty.

In still another aspect, an RMC system 106 can be structured to take advantage of the immunity from liability for libel and slander granted by the Communications Decency Act (“CDA”) to providers of interactive computer services. Where its operations are not protected by the CDA, an RMC system 106 may be able to reduce its risk of liability for defamation substantially by relying only on official sources and other reputable sources, and taking particular care with defamatory information from unofficial sources. In addition the RMC system 106 provider can take reasonable steps to assure itself of the information's accuracy, including insuring that the source of the information is reputable.

The RMC system 106 can operate an interactive computer service as that term is defined in the CDA. The clearinghouse can therefore provide an information service and/or access software that enables computer access by multiple users to a computer server. In one embodiment, if desired, an RMC system 106 provider can limit its employees or agents from creating or developing any of the content in the RMC database 108. Content be maintained unchanged except that the RMC system 106 can remove information from the database that it determines to be inaccurate or irrelevant.

Still other embodiments can incorporate a RMC database 108 transmission of information from the database that will be carefully structured such that the RMC database will not provide “consumer reports” regulated by the FCRA. As such, the data may be limited by not relating to consumers, but rather to corporate entities. Data on consumers can be prevented from identifying them definitively, inasmuch as the individual named in a public record may or may not be the individual who is the subject of a RMC search. Moreover, the RMC system 106 can forego collecting information in order to provide consumer reports, and also not use or have a reasonable basis to expect that subscribers will use any RMC data 108 for FCRA covered purposes.

As an example of such an embodiment, the RMC system 106 can limit collection of data to that information that will be relevant for the detection and prevention of money laundering, fraud, corrupt practices, organized crime, activities subject to governmental sanctions or embargoes, or other similar activity that is the subject of national and/or global regulation. The RMC system 106 can be limited to collecting information for the RMC database 108 solely from publicly-available sources, principally information from news media and information released to the public by government agencies, such as regulatory enforcement action notice and embargo, sanction and criminal-wanted lists.

If desired, in order to help avoid implications with the FCRA, an embodiment can prevent data from including identifiers that would assure the subscriber that the subject of the data is the same person as the subject of the subscriber's inquiry. For example, while the data will typically identify the subject by name, they often will not include a social security number, photograph, postal address, or similar comparatively definitive identification. As many people share identical names, a subscriber often will be unsure whether any or all of the data received relate to the person inquired about.

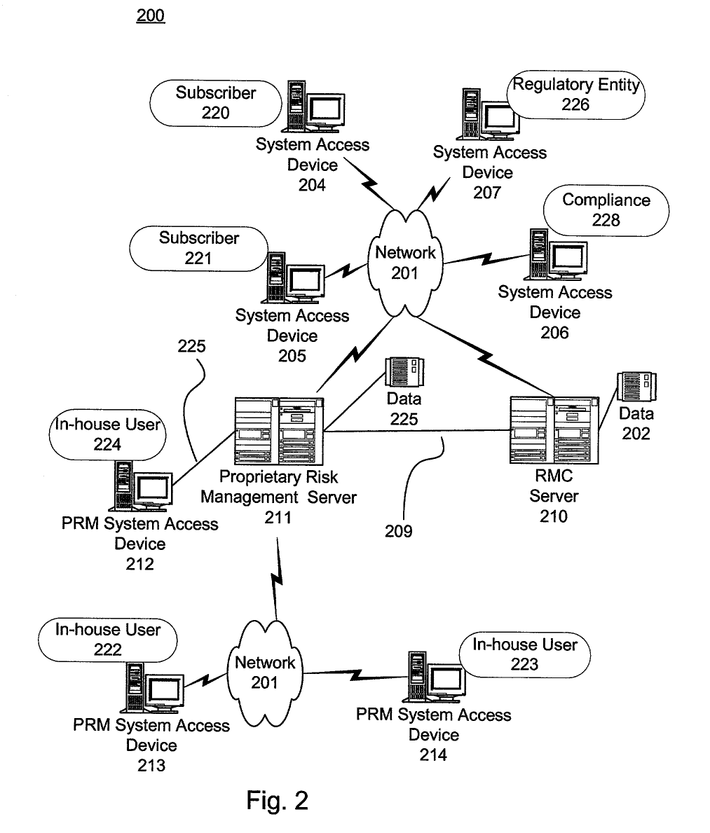

Referring now to FIG. 2, a network diagram illustrating one embodiment of the present invention is shown 200. An automated RMC 106 can include a computerized RMC server 210 accessible via a distributed network 201 such as the Internet, or a private network. A subscriber 220-221, regulatory entity 226, remote user 228, or other party interested in risk management, can use a computerized system or network access device 204-207 to receive, input, transmit or view information processed in the RMC server 210. A protocol, such as the transmission control protocol internet protocol (TCP/IP) can be utilized to provide consistency and reliability.

In addition, an RMC server 210 can access the RMC server 210 via the network 201 or via a direct link 209, such as a T1 line or other high speed pipe. The RMC server 210 can in turn be accessed by an in-house user 222-224 via a system access device 212-214 and a distributed network 201, such as a local area network, or other private network, or even the Internet, if desired. An in-house user 224 can also be situated to access the RMC server 210 via a direct link 225, or any other system architecture conducive to a particular need or situation. In one embodiment, a remote user can access the RMC server 210 via a system access device 204-207 also used to access other services, such as an RMC server 210.

A computerized system or system access device 204-207 212-214 used to access the RMC server 210 or the PRM server 211 can include a processor, memory and a user input device, such as a keyboard and/or mouse, and a user output device, such as a display screen and/or printer. The system access devices 204-207 212-214 can communicate with the RMC server 210 or the PRM server 211 to access data and programs stored at the respective servers 210-211. The system access device 212-214 may interact with the server 210-211 as if the RMC risk management system 211 were a single entity in the network 200. However, the servers 210-211 may include multiple processing and database sub-systems, such as cooperative or redundant processing and/or database servers that can be geographically dispersed throughout the network 200.

The RMC server 210 includes one or more databases 225 storing data relating to proprietary risk management. The RMC server 210 may interact with and/or gather data from an operator of a system access device 220-224 226 228 or other source, such as from the RMC server 210. Data received may be structured according to risk criteria and utilized to calculate a risk quotient 108.

Typically an in-house user 222-224 or other user 220-221, 226, 228 will access the RMC server 210 using client software executed at a system access device 212-214. The client software may include a generic hypertext markup language (HTML) browser, such as Netscape Navigator or Microsoft Internet Explorer, (a “WEB browser”). The client software may also be a proprietary browser, and/or other host access software. In some cases, an executable program, such as a Java™ program, may be downloaded from the RMC server 210 to the client computer and executed at the system access device or computer as part of the RMC risk management software. Other implementations include proprietary software installed from a computer readable medium, such as a CD ROM. The invention may therefore be implemented in digital electronic circuitry, computer hardware, firmware, software, or in combinations of the above. Apparatus of the invention may be implemented in a computer program product tangibly embodied in a machine-readable storage device for execution by a programmable processor; and method steps of the invention may be performed by a programmable processor executing a program of instructions to perform functions of the invention by operating on input data and generating output.

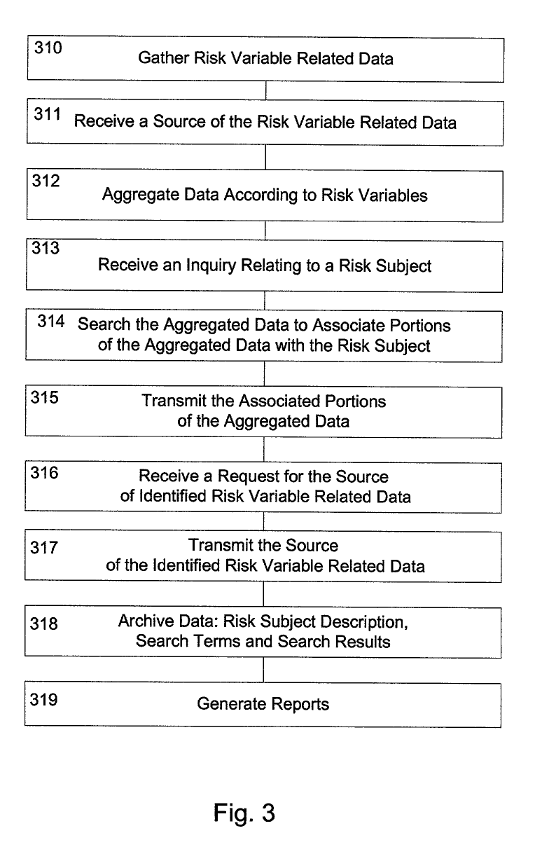

Referring now to FIG. 3, steps taken to manage risk associated with a financial transaction can include gathering data relating to risk entities and other risk variables 310 and receiving the gathered information into an RMC server 210. Informational data can be gathered from a user such as a Financial Institution employee, from a source of electronic data such as an external database, messaging system, news feed, government agency, from any other automated data provider, from a party to a transaction, or other source. Typically, the RMC server 210 will receive data relating to a transactor, beneficiary, institutional entity, geographic area, shell bank, or other related party. Information can be received on an ongoing basis such that if new events occur in the world that affect the exposure of a transactor, the calculated risk can be adjusted accordingly.

A source of risk variable data can also be received 311 by the RMC server 210 or other provider of risk management related data. For example, a source of risk variable data may include a government agency, an investigation firm, public records, news reports, publications issued by Treasury's Financial Crimes Enforcement Network (“FinCEN”), the State Department, the CIA, the General Accounting Office, Congress, the Financial Action Task Force (“FATF”), various international financial institutions (such as the World Bank and the International Monetary Fund), the United Nations, other government and non-government organizations, internet websites, news feeds, commercial databases, or other information sources.

The RMC server 210 can aggregate the data received according to risk variables 312 or according to any other data structure conducive to fielding risk.

A RMC server 210 can be accessed in real time, or on a transaction by transaction basis. In the real time embodiment, any changes to the RMC data 108 may be automatically forwarded to an in-house PRM system 106. On a transaction by transaction basis, the RMC system 106 can be queried for specific data that relates to variables associated with a particular transaction.

All data received can be combined and aggregated 312 to create an aggregate source of data which can be accessed to perform risk management activities. Combining data can be accomplished by any known data manipulation method. For example, the data can be maintained in separate tables and linked with relational linkages, or the data can be gathered into on comprehensive table or other data structure. In addition, if desired, information received can be associated with one or more variables including a position held by the account holder or other transactor, the country in which the position is held, how long the position has been held, the strength of the position, the veracity of previous dealings with persons from that country, the propensity of people in similar positions to execute unlawful or unethical transactions, the type of transaction or other criteria.

In addition to the types and sources of risk variable data listed previously that can provide indications of high risk, received information can relate to variables such as: involving a financial institution that is not accustomed to foreign account activity; requests for secrecy or exceptions to Bank Secrecy Act requirements, routing through a secrecy jurisdiction, or missing wire transfer information; unusual and unexplained find or transaction activity, such as fund flow through several jurisdictions or financial institutions, use of a government-owned bank, excessive funds or wire transfers, rapid increase or decrease of funds or asset value not attributable to the market value of investments, high value deposits or withdrawals, wires of the same amount of funds into and out of the account, and frequent zeroing of account balance; and large currency or bearer transactions, or structuring of transactions below reporting thresholds. Other risk variable data can be received include activities a person or entity is involved in, associates of a transactor, governmental changes, attempting to open more than one account in the same time proximity, or other related events.

The RMC server 210 or PRM server 211 can receive an inquiry relating to a risk subject 313. The risk subject can be any subject related to the variables discussed above, for example, a risk subject can include the parties involved in a transaction as well as any institution involved.

The inquiry from a subscriber, or other authorized entity, can cause the respective servers 210-211 to search the aggregated data and associate related portions of aggregated data with the risk subject 314. The associated portions of aggregated data can be transmitted 315 to a party designated by the requesting subscriber.

The RMC server 210 may also receive a request for the source of identified risk variable related data 316, in which case, the RMC server 210 can transmit the source of the identified risk variable related data to the requester 317. The source may be useful in adding credibility to the data, or to follow up with to request additional information.

The RMC server 210 can also store in memory, or otherwise archive risk management related data and proceedings 318. Archived risk management related data and proceedings can be useful to quantify corporate governance and diligent efforts to address high risk situations. Accordingly, reports quantifying RMC risk management risk management procedures, executed due diligence, corporate governance or other matters can be generated 319.

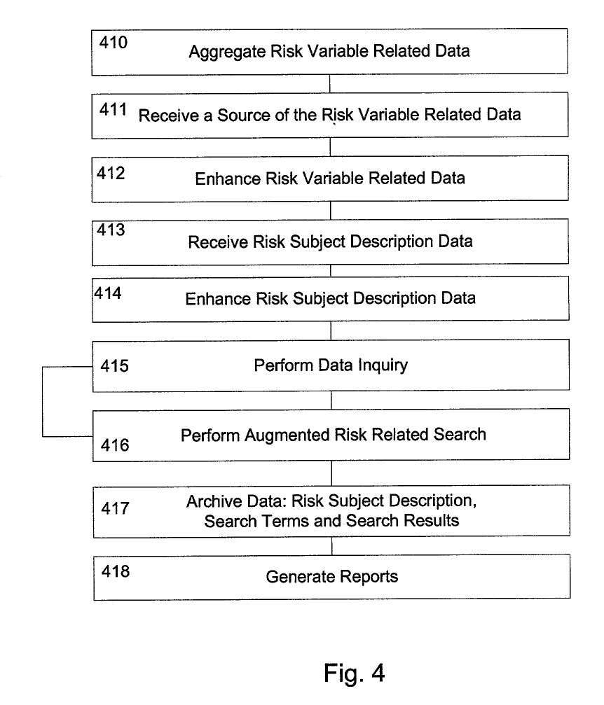

Referring now to FIG. 4, the present invention can also include steps that allow an RMC server 210 or PRM server 211 to provide data augmenting functionality that allows for more accurate processing of data related to risk management. Accordingly, a RMC server 210 or PRM server 211 can aggregate risk variable related data 410 and also the source of the risk variable related data 411. The RMC server 210 or PRM server 211 can also enhance the risk variable related data, such as through data scrubbing techniques or indexing as discussed above. A risk subject description can also be received 413 and also scrubbed or otherwise enhanced 414.

An inquiry can be performed against the aggregated and enhanced data 415. In addition, an augmented search that incorporates data mining techniques 416 can also be included to further expand the depth of knowledge retrieved by the inquiry. If desired, a new inquiry can be formed as a result of the augmented search. This process can continue until the inquiry and augmentation ceases to add any additional meaningful value.

As discussed above, any searching and augmentation can be archived 417 and reports generated to quantify the due diligence efforts 418.

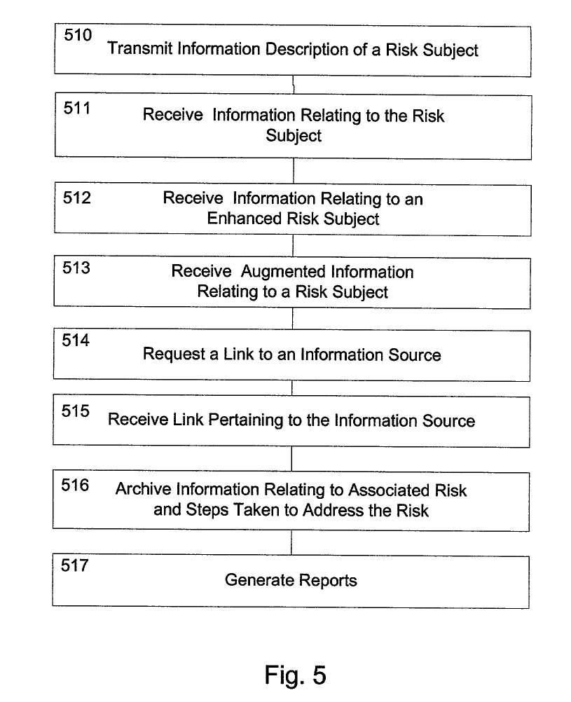

Referring now to FIG. 5, a flow chart illustrates steps that a user, such as a financial institution, can implement to manage risk associated with a transaction. The user can receive information descriptive of a risk subject, such as an entity associated with a transaction 510. This information may be received during the normal course of business, such as when the participants to a transaction are ascertained. The user can access an RMC server 210 and identify to the RMC server 210 one or more entities, jurisdictions, or other risk variables involved in the transaction 511. Access can be accomplished by opening a dialogue with an RMC system 211 with a network access device, 204-207, 212-214. Typically, the dialogue would be opened by presenting a GUI to a network access device accessible by a person or an electronic feed that will enter information relating to the transactor. The GUI will be capable of accepting data input via a network access device. An example of a GUI would include a series of questions relating to a transaction. Alternatively, information can be received directly into fields of a database, such as from a commercial data source. Questions can be fielded during a transaction, or at any other opportunity to gather information.

In one embodiment, automated monitoring software can run in the background of a normal transaction program and screen data traversing an application. The screened data can be processed to determine key words wherein the key words can in turn be presented to the RMC server 210 as risk subjects or risk variables. The RMC server 210 will process the key words to identify entities or other risk variables. Monitoring software can also be installed to screen data traversing a network or communications link.

The user will receive back information relating to risk associated with conducting a transaction involving the submitted subject 512. The information can include enhanced data, such as scrubbed data. In one embodiment, a user can receive ongoing monitoring of key words, identified entities, a geographic location, or other subject, or list of subjects. Any updated information or change of status detected via an ongoing monitoring can result in an alarm or other alert being sent to one or more appropriate users.

The user can also receive augmented information 513, such as data that has been processed through data mining techniques discussed above.

In addition to receiving augmented information 513, a user can also request a identifier, such as a link to a source of information 514. Receipt of a link pertaining to a source of information 515 may be useful to pursue more details relating to the information, or may be utilized to help determine the credibility of the information received.

A user can also cause an archive to be created relating to the risk management 516. An archive may include, for example, information received relating to risk associated with a transaction, inquiries made and results of each inquiry. In addition, the user can cause an RMC server 210 to generate reports to quantify the archived information and otherwise document diligent actions taken relating to risk management 517.

A number of embodiments of the present invention have been described. Nevertheless, it will be understood that various modifications may be made without departing from the spirit and scope of the invention. For example, network access devices 204-207, 212-214 can comprise a personal computer executing an operating system such as Microsoft Windows™, Unix™, or Apple Mac OS™, as well as software applications, such as a JAVA program or a web browser. network access devices 204-207, 212-214 can also be a terminal device, a palm-type computer, mobile WEB access device, a TV WEB browser or other device that can adhere to a point-to-point or network communication protocol such as the Internet protocol. Computers and network access devices can include a processor, RAM and/or ROM memory, a display capability, an input device and hard disk or other relatively permanent storage. Accordingly, other embodiments are within the scope of the following claims.

What is claimed is:

1. A computer-implemented method for managing risk associated with government regulation, the method comprising:
gathering data relevant to regulation from multiple sources;
aggregating the data gathered according to risk variables;
receiving an inquiry relating to a risk subject;
associating portions of the aggregated data with the risk subject; and
transmitting the associated portions of the aggregated data.

2. The method of claim 1 wherein the gathered data is gathered exclusively from publicly available sources.

3. The method of claim 1 wherein the inquiry received is a system to system inquiry involving batch screening requests.

4. The method of claim 1 wherein the inquiry received is an individual inquiry received electronically.

5. The method of claim 1 wherein the inquiry received is an individual inquiry received via facsimile.

6. The method of claim 1 wherein the inquiry received is an individual inquiry received via voice communication.

7. The method of claim 1 additionally comprising the step of receiving a contractual obligation not to use the associated portions of the aggregated data for any purpose covered by the Fair Credit Reporting Act.

8. The method of claim 1 wherein transmitting the associated portions of the aggregated data is conditioned upon receipt of the contractual obligation not to use the associated portions of the aggregated data for any purpose covered by the Fair Credit Reporting Act.

9. The method of claim 1 wherein the gathered data does relates to commercial entities.

10. The method of claim 2 wherein the associated portions of the aggregated data is transmitted exclusively to an institution, such that the transmitter will have neither customers nor consumers as defined in the Gramm-Leach-Bliley Act.

11. The method of claim 1 wherein transmitting the associated portions of the aggregated data is conditioned upon receipt of a contractual obligation to limit use of the aggregated data for complying with regulatory and legal obligations associated with at least one of: (i) the detection and prevention of money laundering, (ii) fraud, (iii) corrupt practices, (iv) organized crime, and (v) activities subject to government sanctions or embargoes.

12. The method of claim 1 wherein transmitting the associated portions of the aggregated data is conditioned upon receipt of a contractual obligation to limit use of the aggregated data for at least one of: (i) the prevention or detection of a crime, (ii) the apprehension or prosecution of offenders, and (iii) the assessment or collection of a tax or duty.

13. The method of claim 1 wherein the gathered data relevant to regulation does not include information sourced from a credit report.

14. The method of claim 1 wherein the gathered data related relevant to regulation accurately reports on or consists of a governmental record.

15. The method of claim 1 additionally comprising the step of insuring that the source of gathered data relevant to regulation is reputable.

16. The method of claim 1 wherein none of the associated portions of the aggregated data transmitted comprises any content created or developed by a provider of the computer-implemented method for managing risk associated with government regulation.

17. The method of claim 1 wherein none of the aggregated data comprises any consumer reporting data.

18. The method of claim 1 additionally comprising the step of generating a report relating to a financial institution's obligation to know their customer, wherein the report comprises the inquiry and the associated portions of the aggregated data.

19. The method of claim 1 additionally comprising the step of generating a report relating to a financial institution's obligation to file Suspicious Activity Reports, wherein the generated report comprises the inquiry and the associated portions of the aggregated data.

20. The method of claim 1 wherein the risk subject comprises details descriptive of a financial transaction.

21. The method of claim 1 wherein the risk subject comprises parties involved in a financial transaction.

22. The method of claim 1 wherein the inquiry relating to a risk subject comprises an alert list.

23. The method of claim 22 additionally comprising the steps of continually monitoring the aggregated data and transmitting any new information related the risk subject.

24. A computer-implemented method for managing risk, the method comprising:
gathering data related to risk variables from multiple sources;
aggregating the data gathered according to risk variables;
receiving data descriptive of a risk subject;
associating portions of the aggregated data with the risk subject; and
transmitting the associated portions of the aggregated data.

25. The method of claim 24 additionally comprising the step of enhancing the gathered data.

26. The method of claim 25 additionally comprising the step of enhancing the data descriptive of the risk subject.

27. The method of claim 25 or 23 wherein enhancing the data comprises scrubbing the data to incorporate changes in the spelling of the risk subject.

28. The method of claim 25 or 23 wherein enhancing the data comprises utilization of an index file.

29. The method of claim 24 additionally comprising the step of augmenting the associated portions of aggregated data.

30. The method of claim 29 wherein augmenting the data comprises data mining.

31. The method of claim 24 wherein associating portions of aggregated data comprises Boolean logic.

32. The method of claim 24 wherein associating portions of aggregated data comprises relevance ranking.

33. The method of claim 24 additionally comprising the steps of receiving a source of gathered data and transmitting the source of the associated portions of aggregated data.

34. A computerized system for managing risk, the system comprising:
a computer server accessible with a system access device via a communications network; and
executable software stored on the server and executable on demand, the software operative with the server to cause the system to:
gather data related relevant to regulation from publicly available sources;
aggregate the data gathered according to risk variables;
receive an inquiry relating to a risk subject;
associate portions of the aggregated data with the risk subject; and
transmit the associated portions of the aggregated data.

35. The computerized system of claim 34 wherein the data is gathered via an electronic feed.

36. Computer executable program code residing on a computer-readable medium, the program code comprising instructions for causing the computer to:
gather data related relevant to regulation from publicly available sources;
aggregate the data gathered according to risk variables;
receive an inquiry relating to a risk subject;
associate portions of the aggregated data with the risk subject; and
transmit the associated portions of the aggregated data.

37. A computer data signal embodied in a digital data stream comprising data relating to risk management, wherein the computer data signal is generated by a method comprising the steps of:
gathering data relevant to regulation from multiple sources;
aggregating the data gathered according to risk variables;
receiving an inquiry relating to a risk subject;
associating portions of the aggregated data with the risk subject; and
transmitting the associated portions of the aggregated data.

38. A method of interacting with a network access device so as to manage risk relating to a risk subject, the method comprising the steps of:
initiating interaction with a risk management server via a communications network;
inputting information descriptive of the risk subject to regulation;
transmitting the information descriptive of a risk subject to a risk management clearinghouse server; and
and receiving data associated with risk variables that relate to the risk subject.

39. The method of claim 38 wherein the risk subject is a financial transaction.

40. The method of claim 38 wherein the data received comprises data resultant to data mining.
